(19) United States
(12) Patent Application Publication
(10) Pub. No.: US 2023/0182439 A1
(43) Pub. Date: Jun. 15, 2023

(54) MOLDED ARTICLE AND METHOD OF PRODUCING SAME

(71) Applicant: Toray Industries, Inc., Tokyo (JP)

(72) Inventors: Yuki Mitsutsuji, Nagoya-shi, Aichi (JP); Masahiro Hashimoto, Nagoya-shi, Aichi (JP); Masaru Tateyama, Nagoya-shi, Aichi (JP); Wataru Hasegawa, Nagoya-shi, Aichi (JP)

(21) Appl. No.: 17/925,439

(22) PCT Filed: May 27, 2021
(86) PCT No.: PCT/JP2021/020175

§ 371 Date: Nov. 15, 2022

(30) Foreign Application Priority Data
Jun. 1, 2020 (JP) 2020-095201
Jan. 5, 2021 (JP) 2021-000381

(51) Int. Cl. B32B 7/027; B32B 27/28

(52) U.S. Cl. CPC B32B 7/027; B32B 27/286; B32B 2307/30; B32B 2250/03; B32B 2250/24; B29C 70/42

(57) ABSTRACT

A molded article includes a fiber-reinforced composite material in which reinforcing fibers are impregnated with a matrix resin, wherein components A, B, and C: Component A: a fiber-reinforced base material in which continuous reinforcing fibers are impregnated with a PPS resin is applied as the matrix resin, and a volume content of fiber Vf′_{A} in the component A is Vf′_{A}=50 to 70 vol %; Component B: a fiber-reinforced base material in which the continuous reinforcing fibers are impregnated with the matrix resin, the PPS resin and a PPS resin having a melting point Tm_{B} lower than a melting point Tm_{A} of the PPS resin are applied as the matrix resins, and a volume content of fiber Vf′_{B} in the component B is Vf′_{B}<Vf′_{A}; and Component C: a fiber-reinforced resin obtained by impregnating discontinuous reinforcing fibers with the PPS resin is applied as the matrix resin.

### TECHNICAL FIELD

This disclosure relates to a molded article formed by integrating a plurality of fiber-reinforced composite materials, for example, an integrally molded article obtained by bonding a fiber-reinforced composite material containing discontinuous fibers to a fiber-reinforced composite material in which continuous reinforcing fibers are impregnated with a matrix resin by injection molding, and a method of producing the same.

### BACKGROUND

A method of bonding a fiber-reinforced resin of a thermosetting resin and a fiber-reinforced resin of a thermoplastic resin to produce a composite molded body is known, and a method of using an injection molding material as the thermoplastic resin to perform injection bonding and integration is known. (JP 3906319 B2)

Furthermore, as a method of injection bonding and integrating an injection molding material and a continuous fiber-reinforced member in which a thermoplastic resin is a matrix resin, a method of disposing an adhesive layer on a continuous fiber-reinforced member is known. (JP 5500177 B2)

However, when highly heat-resistant polyphenylene sulfide (PPS) is used as the matrix resin for the continuous fiber-reinforced member and the injection molding material, the continuous fiber-reinforced member may be thermally decomposed or the fibers may be twisted due to a high injection temperature of the PPS resin. In addition, since a crystallization rate of the PPS resin is high, a bond strength as expected cannot be obtained, and strength and rigidity as an integrally molded article may be insufficient.

It could therefore be helpful to provide a high bond strength and efficiently mold a molded article excellent in strength and rigidity when injection-bonding an injection molding material containing discontinuous fibers and a PPS resin to a continuous fiber-reinforced composite material using the PPS resin.

### SUMMARY

We thus provide:

(1) A molded article comprising a fiber-reinforced composite material in which the reinforcing fibers are impregnated with a matrix resin, wherein three components A, B, and C below are arranged in that order:

Component A: a fiber-reinforced base material in which continuous reinforcing fibers are impregnated with the matrix resin, in which a PPS resin [1] is applied as the matrix resin, and a volume content of fiber Vf′_{A} in the component A is Vf′_{A}=50 to 70 vol %.

Component B: a fiber-reinforced base material in which the continuous reinforcing fibers are impregnated with the matrix resin, a PPS resin [1] and a PPS resin [2] having a melting point Tm_{B} lower than a melting point Tm_{A} of the PPS resin [1] are applied as the matrix resins, and a volume content of fiber Vf′_{B} in the component B is Vf′_{B}<Vf′_{A}.

Component C: a fiber-reinforced resin obtained by impregnating discontinuous reinforcing fibers with the matrix resin, in which the PPS resin [1] is applied as the matrix resin.

(2) A molded article containing a fiber-reinforced composite material in which reinforcing fibers are impregnated with a matrix resin, wherein at least one surface of the fiber-reinforced composite material is bonded and integrated by injection molding of a thermoplastic resin, wherein three components A, B, and C below are bonded in that order:

Component A: a fiber-reinforced base material in which continuous reinforcing fibers are impregnated with the matrix resin, in which a PPS resin [1] is applied as the matrix resin, and a volume content of fiber Vf_{A} in the component A is Vf_{A}=50 to 70 vol %.

Component B: a fiber-reinforced base material in which the continuous reinforcing fibers are impregnated with the matrix resin, the PPS resin [1] and a PPS resin [2] having a melting point Tm_{B} lower than a melting point Tm_{A} of the PPS resin [1] are applied as the matrix resins, and a volume content of fiber Vf_{B} in the component B is Vf_{B}<Vf_{A}.

Component C: a fiber-reinforced resin obtained by impregnating discontinuous reinforcing fibers with the matrix resin, in which the PPS resin [1] is applied as the matrix resin.

(3) A method of producing a molded article by injection molding a thermoplastic resin on at least one surface of the fiber-reinforced composite material in which the reinforcing fibers are impregnated with the matrix resin to bond and integrate the fiber-reinforced composite material, the method comprising:

obtaining the fiber-reinforced composite material by heating, melting and molding, a fiber-reinforced base material [A] in which continuous reinforcing fibers are impregnated with the matrix resin, in which a PPS resin [1] is applied as the matrix resin, and a volume content of fiber Vf_{A} in a component A is Vf_{A}=50 to 70 vol %, and a fiber-reinforced base material [B] in which the continuous reinforcing fibers are impregnated with the matrix resin, the PPS resin [1] and a PPS resin [2] having a melting point Tm_{B} lower than a melting point Tm_{A} of the PPS resin [1] are applied as the matrix resins, and a volume content of fiber Vf_{B} in a component B is Vf_{B}<Vf_{A}, to a specific shape, and

injecting and integrating a fiber-reinforced resin that is obtained by impregnating discontinuous reinforcing fibers with the matrix resin and to which the PPS resin [1] is applied as the matrix resin to the fiber-reinforced composite material obtained in the step 1 to obtain a molded article.

According to our molded articles, it is possible to efficiently mold a complicated shape by, for example, injection molding, and it is possible to obtain molded articles having an excellent bond strength in a plurality of components, a high mechanical strength and rigidity due to the fiber-reinforced base material containing continuous fibers, a heat resistance due to the PPS resin, and also an excellent recycling performance.

### BRIEF DESCRIPTION OF THE DRAWINGS

FIG. 1 shows an example of a form in which components of a molded article are laminated.

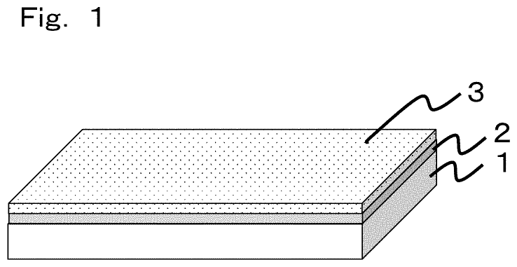

FIG. 2 shows another example of the form in which the components of the molded article are laminated.

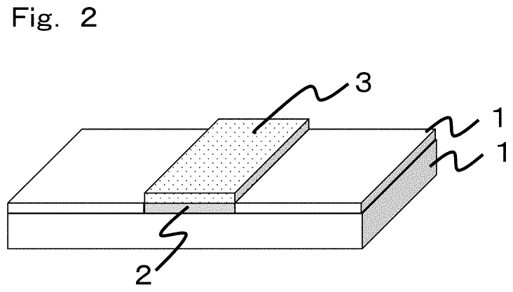

FIG. 3 shows an example of a multilayer structure of a component B.

FIG. 4 shows a cross-sectional view of the molded article.

### DESCRIPTION OF REFERENCE SIGNS

1: Component A
2: Component B
21: PPS resin [1] constituting component B
22: PPS resin [2] constituting component B
3: Component C

### DETAILED DESCRIPTION

Our molded articles basically include a component A, a component B, and a component C, and are obtained by, for example, injecting and integrating the component C into a laminate of the components A and B. Furthermore, since the components A and B are integrated to change the form of their bonded surfaces, first, the form before integration will be described in detail below.

### Component A

Details of the component A will be described below.

Component A is a fiber-reinforced base material in which continuous reinforcing fibers are impregnated with a matrix resin, and a PPS resin [1] is applied as the matrix resin.

The type of reinforcing fiber to be used is not particularly limited, and carbon fibers, glass fibers, aramid fibers and the like can be used, and a hybrid configuration in which these fibers are combined can also be used. When seeking a design of strength, ease of production and the like as a molded body in which the components A, B, and C are combined, a form containing the carbon fibers is particularly preferable.

The PPS resin [1] to be used is a heat-resistant polymer composed of a benzene ring and a sulfur, and has a melting point of preferably 270 to 280° C.

As the content of the matrix resin, it is important that a volume content of fiber Vf_{A} in the component A is Vf_{A}=50 to 70 vol %. The content is preferably 55 to 65 vol % from a view-point of mechanical properties and moldability. Furthermore, since the volume content of fiber in the component A may change after molding, the volume content of fiber before molding is denoted by Vf_{A}, and the volume content of fiber after molding is denoted by Vf′_{A} in the present description.

The method of producing the component A is not particularly limited, and examples thereof include a method in which the aligned reinforcing fibers are passed through a resin bath of the molten PPS resin [1] and squeezed with a bar to produce the fiber-reinforced base material in which the reinforcing fibers are impregnated with the PPS resin [1] and the like.

Furthermore, any number of base materials obtained by the above method may be prepared, and these may be laminated and integrated by heating to a temperature at which the PPS resin [1] is melted.

Component B

Details of the component B will be described below.

Component B is a fiber-reinforced base material in which the continuous reinforcing fibers are impregnated with the matrix resin, and has two types of PPS resins having different melting points as the matrix resins. As these two types of PPS resins, the same PPS resin [1] as used in the component A described above and a PPS resin [2] having a melting point Tm_{B} lower than a melting point Tm_{A} of the PPS resin [1] are applied. The PPS resin [2] is preferably disposed at least on the component C side. Furthermore, it is important that the volume content of fiber Vf_{B} in the component B satisfies a relationship of Vf_{B}<Vf_{A}. In addition, since the volume content of fiber in the component B may change after molding, the volume content of fiber before molding is denoted by Vf_{B}, and the volume content of fiber after molding is denoted by Vf′_{B} in the present description.

The type of reinforcing fibers to be used is not particularly limited, and the carbon fibers, the glass fibers, the aramid fibers and the like can be used, and the hybrid configuration in which these fibers are combined can also be used. When seeking to design strength, the ease of production and the like of the obtained molded body, the form containing the carbon fibers is particularly preferable.

PPS resin [1] used for the component B is as described for the component A. Furthermore, the PPS resin [2] is the heat-resistant polymer composed of the benzene ring and the sulfur, and preferably has the melting point Tm_{B} of 200 to 270° C. Examples of the method of controlling the melting point include using a polymer in which an m-phenylenesulfide unit is co-polymerized with a p-phenylenesulfide unit. From a viewpoint of stability and mechanical properties at the time of injection integration, the melting point Tm_{B} is more preferably 220 to 260° C.

As the content of the matrix resin, it is important that the fiber volume content Vf_{B} before molding as the component B satisfies the relationship of Vf_{B}<Vf_{A}. Specifically, Vf_{B} is preferably 35 to 60 vol %, more preferably 38 to 55 vol % from the viewpoint of moldability. When Vf_{B} is within the above range, the component C is easily injection welded to the component A via the component B, and the bond strength between the layers can be efficiently increased.

The method of producing the component B is not particularly limited, and examples thereof include a method in which the aligned reinforcing fibers are passed through the resin bath containing the molten PPS resin [1] and the PPS resin [2] molt, and squeezed with the bar to produce the fiber-reinforced base material in which the reinforcing fibers are impregnated with the PPS resin [1] and the PPS resin [2]. Alternatively, the aligned reinforcing fibers may be passed through the resin bath of the molten PPS resin [1] and squeezed with the bar to produce a fiber-reinforced base material precursor in which the reinforcing fibers are impregnated with the PPS resin [1], and then a film of the PPS resin [2] may be laminated on the fiber-reinforced base material precursor to form the component B. Furthermore, the film of the PPS resin [2] may be prepared, and the PPS resin [2] and the reinforcing fibers in the component A may constitute the component B in the molded article.

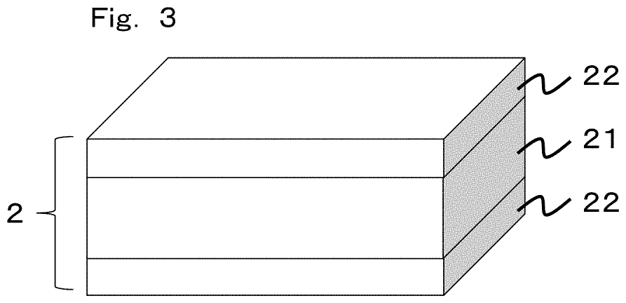

The component B may have a multilayer structure for multifunctional addition. As an example, from the viewpoint of bond strength with both the components A and C, as shown in FIG. 3, the center in a thickness direction is desirably a PPS resin [1] 21, and outermost layers on both sides of the component B (that is, outermost layers bonded to the component A or the component C) are desirably a PPS resin [2] 22.

In addition, the PPS resin [2] before molding in the component B is preferably 33 to 100 Vol % from viewpoints of mechanical characteristics and moldability.

In the component B, it is preferable to provide the PPS resin [1] and the PPS resin [2] in layers as described above. For example, to exhibit an anchoring effect by the resin between the layers of the component B and the component C after molding, it is preferable to have the PPS resin [2] having a low melting point on the component C side. Furthermore, in this example, it is preferable that the PPS resin [2] is present in a region of 100 μm or less starting from a surface forming an interface with the component C to be described later. In other words, a thickness of the layer of the PPS resin [2] is preferably 100 μm or less. When the thickness of the PPS resin [2] is too large, it may be undesirable from the viewpoint of heat resistance. The thickness of the layer of the PPS resin [2] is more preferably 80 μm or less. The interface is basically formed between the PPS resin [1] and the PPS resin [2], and the PPS resin [1] and the PPS resin [2] can be separated by color. However, as a specific evaluation method, the PPS resin [1] and the PPS resin [2] can be evaluated from the melting point by DSC by cutting the PPS resin [1] and the PPS resin [2] to an arbitrary depth from the surface. For example, when the melting point is 5° C. lower than the melting point of the PPS resin [2] to be used, the resin is determined not to be the PPS [2].

### Component C

Details of the component C will be described below.

Component C is a fiber-reinforced resin in which the discontinuous reinforcing fibers are impregnated with the matrix resin, and is made of an injection molding material to which the PPS resin [1] is applied as the matrix resin.

The type of reinforcing fibers to be used is not particularly limited, and the carbon fibers, the glass fibers, the aramid fibers and the like can be used, and the hybrid configuration in which these fibers are combined can also be used. When seeking to design strength, ease of production and the like of the obtained molded body, the form containing the carbon fibers is particularly preferable.

A content Wfc of the reinforcing fibers in the component C is not particularly limited, but is preferably Wfc=10 to 50 wt % from the viewpoints of mechanical characteristics and moldability. The content is more preferably 15 to 35 wt %.

Furthermore, examples of the form of the injection molding material include short fiber pellets and long fiber pellets.

### Steps for Producing Molded Article

The process for producing a molded article will be described in detail.

The molded articles are a molded article in which the component A, the component B, and the component C described above are arranged and bonded in the order, and is obtained by, for example, setting the laminate of the component A and the component B in an injection molding mold and injection welding the component C to the laminate to be integrated. Furthermore, when the laminate of the fiber-reinforced base material precursor and the film as described above is used as the component B, the laminate is melt crimped, molded, and integrated by a process to be described later, whereby the fiber-reinforced base material in which the continuous reinforcing fibers are impregnated with the matrix resin can be obtained. Specifically, it is preferable to heat the laminate to 200 to 280° C. while applying a constant pressure to the laminate. Heating in this temperature range makes it possible to impregnate the fiber-reinforced base material precursor with the PPS resin [2] without air entrainment and deterioration. Moreover, when the film of the PPS resin [2] is prepared as a starting material of the component B and the PPS resin [2] and the reinforcing fibers in the component A constitute the component B in a molded article, the laminate of the film of the PPS resin [2] and the component A is set in the injection molding mold, melt crimped, and molded, and then the component C is injection welded.

A laminated configuration of the components A, B, and C does not need to be homogeneous in a plane direction of the molded article, and may be the configuration described above at least in a part. For example, the component C may be partially injection-molded in the plane direction such as when a rib shape is formed, but it is desirable that the component A is exposed instead of the component B in other portions where the component C is not injected from the viewpoints of appearance and quality.

When the component C is provided only in a part in the plane direction of the molded article, the PPS resin [2] is preferably provided on the corresponding surface of the component B bonded and integrated with the component C. The region where the PPS resin [2] is provided is not particularly limited, and can be appropriately arranged as long as it is a region including at least a position where the component C is provided as the molded article. Moreover, to ensure the mechanical properties and the like of the molded article, it is preferable that only the component A is exposed in a region of a surface where the component C is not integrated.

Next, the step of producing the molded article can be mainly divided into two steps.

Step 1 produces a fiber-reinforced composite material in which the component A and the component B are laminated, heated and melted, and then molded into a specific shape. Examples of the method of molding into a specific shape include a press molding.

Step 1 can be further divided into a step 1-A in which the component A and the component B are laminated, heated to 200 to 280° C., and bonded to form an intermediate molded article, and a step 1-B in which the intermediate molded article obtained in the step 1-A is heated to 280 to 450° C., and molded into a specific shape to form the fiber-reinforced composite material. In step 1-B, it is more preferable to heat the intermediate molded article to 350 to 450° C.

Step 2 sets the fiber-reinforced composite material obtained in step 1 in an injection molding mold and the component C is injection-molded to be integrated.

### Molded Article

As described above, our molded articles are obtained by bonding and integrating the component A, the component B, and the component C in that order and, for example, it is preferable to obtain the molded article by injection molding the component C containing a molded thermoplastic resin to the fiber-reinforced composite material obtained by bonding the component A and the component B.

In such a molded article, through the steps as described above, the resin of each of the components A, B, and C flows and penetrates into each other in regions of the adjacent components so that a boundary interface of a resin layer has an uneven shape. Therefore, the volume content of fiber in each layer may change from that before molding. Accordingly, the volume content of fiber of the component A in the finally obtained molded article is denoted by Vf′_{A}, and the volume content of fiber of the component B is denoted by Vf′_{B}, but the volume content of fiber Vf′_{A} after molding in the component A is preferably Vf′_{A}=50 to 70 vol % from the viewpoints of mechanical characteristics (the bond strength between the components and strength/rigidity as the molded article) and moldability (molding efficiency). Furthermore, the volume content of fiber Vf′_{B} after molding in the component B is preferably Vf′_{B}<Vf′_{A}. Moreover, from the viewpoint of efficiently increasing the bond strength, the volume content of fiber Vf′_{B} after molding in the component B is more preferably 20 to 60 vol %, still more preferably 35 to 60 vol %, and most preferably 38 to 55 vol %.

### EXAMPLES

Our molded articles and methods will be described further in detail by way of examples, but this disclosure is not limited to the examples described below.

### Evaluation Methods of Properties

(1) Volume Content of Fiber Vf and Vf′

Vf of the base material (component) before molding was calculated using a density measurement result of the base material and the following specific gravity:

Carbon fibers: 1.8 g/cm³

PPS resin: 1.35 g/cm³.

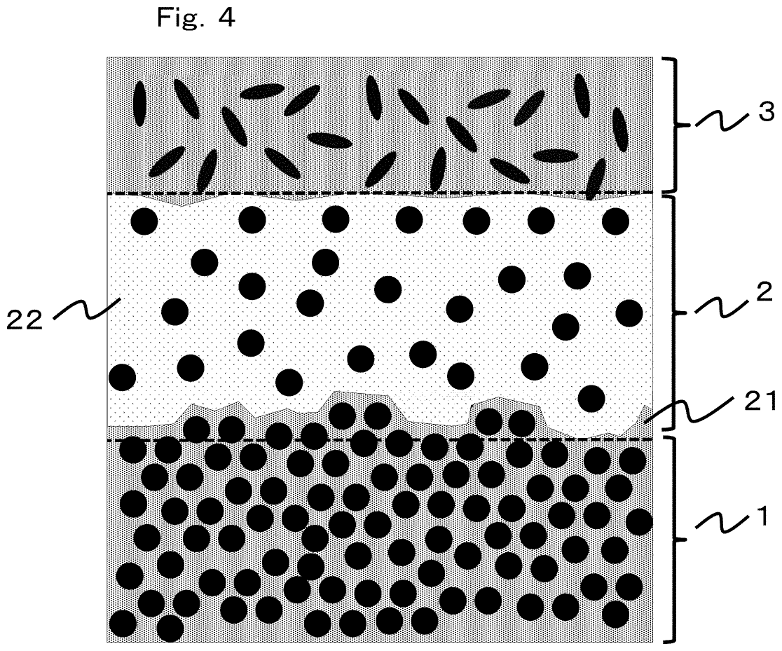

Vf′ of the base material after molding was calculated by observing a cross section of the molded article with a microscope (VHX-6000) and dividing a total area of the reinforcing fibers in the component by the total area of the component. In addition, the area of the component was calculated as the area of a quadrangle obtained by multiplying the thickness of the layer by a machine width. As shown in FIG. 4, the thickness of the layer was measured by dividing the components A, B, and C by two upper and lower sides (indicated by dotted lines) parallel to the surface of the molded article and including the portion of the PPS resin [2] that was most convex outward.

(2) Melting Point Measurement Method

Measurement was performed by DSC at a temperature increase of 10° C./min.

Furthermore, the component B was cut from a surface layer by 10 μm to prepare a sample for measurement.

(3) Bonding Evaluation Method

The base material obtained by heating and melting the component A and the component B at 300° C. and integrating them by pressing was cut into 50 mm×150 mm. The base material was introduced into an injection mold, and the component C was injection welded to a central portion with a width of 20 mm to obtain an integrated molded article. Furthermore, the molding conditions were set to the following conditions A to D, and the cross section was observed after molding under molding conditions A. When a peeling part was observed, a molding temperature was improved in the order of the conditions B, C, and D, and an evaluation was performed. The molded article that could be stably bonded at a lower temperature was evaluated as a good molded article.

Condition A: a mold temperature of 130° C. and a cylinder temperature of 310° C.

Condition B: a mold temperature of 150° C. and a cylinder temperature of 330° C.

Condition C: a mold temperature of 170° C. and a cylinder temperature of 350° C.

Condition D: a mold temperature of 200° C. and a cylinder temperature of 360° C.

### Materials Used in Examples

PPS resin [1]: a melting point of 278° C., and a weight average molecular weight of 50,000
PPS resin [2]: a melting point of 240° C., and a weight average molecular weight of 40,000
Reinforcing fiber [1]: carbon fiber of “Torayca T800”
Reinforcing fiber [2]: carbon fiber of “Torayca T700”

### Example 1

The materials of the components shown in Table 1 were used.

A continuous fiber-reinforced base material (thickness: 0.09 to 0.14 mm) having a Vf_{A} of 60 vol % was prepared by a melt impregnation method using the PPS resin [1] and the reinforcing fibers [1] as the component A.

Furthermore, as the component B, the continuous fiber-reinforced base material (thickness 60 μm, Vf_{B}=40 vol %) having a three-layer structure (both outer layers: the PPS resin [2], and an inner layer: reinforcing fibers [1] impregnated in the PPS resin [1]) was prepared.

The component A: 7 layers (1.0 mm in total) and the component B: 1 layer were combined and once heated at 280° C. for bonding to obtain the intermediate molded article. Subsequently, the temperature was raised to 400° C. by an IR heater and pressed with a mold at 300° C. to prepare the fiber-reinforced composite material having a thickness of 1.02 mm. Furthermore, in the component B, the PPS resin [2] was located in the outermost layer. In addition, the component A was laminated to be quasi-isotropic when laminating the component A: 7 layers.

As the component C, the short fiber pellets (Wf=30%) obtained by compounding the reinforcing fibers [2] and the PPS resin [1] were used.

The fiber-reinforced composite material was cut into a size of 150 mm×50 mm, and the component C was injection welded at the mold temperature of 130° C. and the cylinder temperature of 310° C. to obtain a molded article. The obtained molded article was evaluated. The results are shown in Table 1.

From the cross-section observation, a peeled surface was not observed, and we confirmed that good injection welding was achieved.

### Example 2

As the component A, the continuous fiber-reinforced base material with Vf_{A}=60 vol % was prepared in the same manner as in Example 1. As the component B, the continuous fiber-reinforced base material (thickness 60 μm, Vf_{B}=40 vol %) having a three-layer structure (both outer layers: the PPS resin [2], the inner layer: the reinforcing fibers [1] impregnated in the PPS resin [1]) was prepared.

The component A: 7 layers (1.0 mm in total) and the component B: 1 layer were combined, heated and bonded at 280° C., and press-molded (the process was performed without being divided into two steps) to prepare the fiber-reinforced composite material having a thickness of 1.2 mm.

The molded article was obtained in the same manner as in Example 1 except for the points described above, and as a result of evaluation, the bonding under the evaluation conditions B was possible.

### Example 3

As the component A, the continuous fiber-reinforced base material with Vf_{A}=60 vol % was prepared in the same manner as in Example 1. As the starting material of the component B, the film (thickness: 80 μm) having a three-layer structure (both outer layers: the PPS resin [2], the inner layer: the PPS resin [1]) was prepared.

The component A: 7 layers (1.0 mm in total) and a 3-layered film: 1 layer (the component B) were combined and once heated and bonded at 280° C. to obtain the intermediate molded article. Subsequently, the temperature was raised to 400° C. by the IR heater and pressed with the mold at 300° C. to prepare the fiber-reinforced composite material having a thickness of 0.9 mm. Furthermore, in the obtained fiber-reinforced composite material, an inside of the 3-layered film was impregnated with the reinforcing fibers [1].

The molded article was obtained in the same manner as in Example 1 except for the points described above, and as a result of evaluation, the bonding under evaluation conditions A was possible.

### Example 4

As the component A, the continuous fiber-reinforced base material with Vf_{A}=60 vol % was prepared in the same manner as in Example 1. The film (thickness: 60 μm) of the PPS resin [2] was prepared as the starting material of the component B.

The component A: 7 layers (1.0 mm in total) and the film: 1 layer (the component B) were combined and once heated and bonded at 280° C. to obtain the intermediate molded article. Subsequently, the temperature was raised to 400° C. by the IR heater and pressed with a mold at 300° C. to prepare the fiber-reinforced composite material having a thickness of 1.0 mm. Moreover, in the obtained fiber-reinforced composite material, the inside of the film was impregnated with the reinforcing fibers [1].

The molded article was obtained in the same manner as in Example 1 except for the points described above, and as a result of evaluation, the bonding under the evaluation conditions A was possible.

### Example 5

As the component A, the continuous fiber-reinforced base material with Vf_{A}=60 vol % was prepared in the same manner as in Example 1. As the starting material of the component B, the film (thickness: 40 μm) having a two-layer structure (a layer of the PPS resin [1] and a layer of the PPS resin [2]) was prepared.

The component A: 7 layers (1.0 mm in total) and the film: 1 layer (the component B) were combined and once heated and bonded at 280° C. to obtain the intermediate molded article. Subsequently, the temperature was raised to 400° C. by the IR heater and pressed with a mold at 300° C. to prepare the fiber-reinforced composite material having a thickness of 1.0 mm. Moreover, in the obtained fiber-reinforced composite material, the inside of the film was impregnated with the reinforcing fibers [1].

The molded article was obtained in the same manner as in Example 1 except for the points described above, and as a result of evaluation, the bonding under the evaluation condition C was possible.

### Comparative Example 1

Evaluation was performed in the same manner as in Example 1 except that the intermediate molded article produced only with the component A was used without using the component B. The bonding was not possible under the evaluation conditions A to C, and the bonding was possible only under the evaluation conditions D.

TABLE 1

| | | | | | | | | Comparative |
|---|---|---|---|---|---|---|---|---|
| | | | Example 1 | Example 2 | Example 3 | Example 4 | Example 5 | Example 1 |
| Component | Reinforcing fibers | — | T800 | T800 | T800 | T800 | T800 | T800 |
| A | Resin | — | PPS | PPS | PPS | PPS | PPS | PPS |
| | | | resin [1] | resin [1] | resin [1] | resin [1] | resin [1] | resin [1] |
| | Melting point of resin | ° C. | 278 | 278 | 278 | 278 | 278 | 278 |
| | Vf_{A} before molding | Vol % | 60 | 60 | 60 | 60 | 60 | 60 |
| | Vf_{A} after molding | Vol % | 53 | 59 | 52 | 50 | 56 | 60 |
| Component | Reinforcing fibers | — | T800 | T800 | T800 | T800 | T800 | — |
| B | Resin | — | PPS | PPS | PPS | PPS | PPS | — |
| | | | resin [2]/ | resin [2]/ | resin [2]/ | resin [2] | resin [2]/ | |
| | | | PPS | PPS | PPS | | PPS | |
| | | | resin [1]/ | resin [1]/ | resin [1]/ | | resin [1]/ | |
| | | | PPS | PPS | PPS | | | |
| | | | resin [2] | resin [2] | resin [2] | | | |
| | Melting point of PPS | ° C. | 240 | 240 | 240 | 240 | 240 | — |
| | resin [2] | | | | | | | |
| | Ratio of PPS resin [2] | Vol % | 33 | 33 | 55 | 100 | 50 | — |
| | Step 1-A temperature | ° C. | 280 | 280 | 280 | 280 | 280 | — |
| | Step 1-B temperature | ° C. | 400 | — | 400 | 400 | — | — |
| | Distance from surface | μm | 50 | 60 | 80 | 60 | 40 | — |
| | layer of PPS resin [2] | | | | | | | |
| | Vf_{B} before molding | Vol % | 40 | 40 | 0 | 0 | 0 | 60 |
| | (before step 1) | | | | | | | |
| | Vf_{B} after molding | Vol % | 45 | 40 | 20 | 20 | 10 | 60 |
| Component | Reinforcing fibers | — | T700 | T700 | T700 | T700 | T700 | T700 |
| C | Resin | — | PPS | PPS | PPS | PPS | PPS | PPS |
| | | | resin [1] | resin [1] | resin [1] | resin [1] | resin [1] | resin [1] |
| | Melting point of resin | ° C. | 278 | 278 | 278 | 278 | 278 | 278 |
| | Wf before molding | wt % | 30 | 30 | 30 | 30 | 30 | 30 |
| Evaluation | Bonding with injection | — | A | B | A | A | C | D |
| | molded article | | | | | | | |

### INDUSTRIAL APPLICABILITY

Our molded articles are suitably used for, for example, electric and electronic equipment parts, civil engineering parts, building material parts, structural parts for automobiles, two-wheeled vehicles, aircraft parts and the like.

1-10. (canceled)

11. A molded article comprising a fiber-reinforced composite material in which reinforcing fibers are impregnated with a matrix resin, wherein three components A, B, and C below are arranged in order:
Component A: a fiber-reinforced base material in which continuous reinforcing fibers are impregnated with the matrix resin, in which a PPS resin [1] is applied as the matrix resin, and a volume content of fiber Vf′_{A} in the component A is Vf′_{A}=50 to 70 vol %;
Component B: a fiber-reinforced base material in which the continuous reinforcing fibers are impregnated with the matrix resin, the PPS resin [1] and a PPS resin [2] having a melting point Tm_{B} lower than a melting point Tm_{A} of the PPS resin [1] are applied as the matrix resins, and a volume content of fiber Vf′_{B} in the component B is Vf′_{B}<Vf′_{A}; and
Component C: a fiber-reinforced resin obtained by impregnating discontinuous reinforcing fibers with the matrix resin, in which the PPS resin [1] is applied as the matrix resin.

12. The molded article according to claim 11, wherein Vf′_{B} is 20 to 60 Vol %.

13. A molded article comprising a fiber-reinforced composite material in which reinforcing fibers are impregnated with a matrix resin, wherein at least one surface of the fiber-reinforced composite material is bonded and integrated by injection molding of a thermoplastic resin, wherein three components A, B, and C below are bonded in order:
Component A: a fiber-reinforced base material in which continuous reinforcing fibers are impregnated with the matrix resin, in which a PPS resin [1] is applied as the matrix resin, and a volume content of fiber Vf_{A} in the component A is Vf_{A}=50 to 70 vol %;
Component B: a fiber-reinforced base material in which the continuous reinforcing fibers are impregnated with the matrix resin, the PPS resin [1] and a PPS resin [2] having a melting point Tm_{B} lower than a melting point Tm_{A} of the PPS resin [1] are applied as the matrix resins, and a volume content of fiber Vf_{B} in the component B is Vf_{B}<Vf_{A}; and
Component C: a fiber-reinforced resin obtained by impregnating discontinuous reinforcing fibers with the matrix resin, in which the PPS resin [1] is applied as the matrix resin.

14. The molded article according to claim 13, wherein the fiber-reinforced composite material is formed by bonding the component A and the component B, and the injection molded thermoplastic resin is the component C.

15. The molded article according to claim 13, wherein, in the component B, the PPS resin [2] is present in a region of 100 μm or less starting from an interface between the component B and the component C.

16. The molded article according to claim 13, wherein, in the component B, the PPS resin [1] and the PPS resin [2] have a multilayer structure, and outermost layers on both sides in the component B bonded to the component A and the component C are the PPS resin [2].

17. The molded article according to claim 11, wherein the melting point Tm_{B} of the PPS resin [2] is 220 to 260° C.

18. The molded article according to claim 11, wherein, in the molded article, the components A, B, and C are disposed in that order in a direction perpendicular to a plane direction at a specific portion in the plane direction, the component C is exposed on one surface, and the component A is exposed on a surface at another portion in the plane direction.

19. A method of producing a molded article by injection molding a thermoplastic resin on at least one surface of the fiber-reinforced composite material in which the reinforcing fibers are impregnated with the matrix resin to bond and integrate the fiber-reinforced composite material, the method comprising:
Step 1: a step of obtaining the fiber-reinforced composite material by heating, melting and molding, a fiber-reinforced base material [A] in which continuous reinforcing fibers are impregnated with the matrix resin, in which a PPS resin [1] is applied as the matrix resin, and a volume content of fiber Vf_{A} in a component A is Vf_{A}=50 to 70 vol %, and a fiber-reinforced base material [B] in which the continuous reinforcing fibers are impregnated with the matrix resin, the PPS resin [1] and a PPS resin [2] having a melting point Tm_{B} lower than a melting point Tm_{A} of the PPS resin [1] are applied as the matrix resins, and a volume content of fiber Vf_{B} in a component B is Vf_{B}<Vf_{A}, to a specific shape; and
Step 2: a step of injecting and integrating a fiber-reinforced resin obtained by impregnating discontinuous reinforcing fibers with the matrix resin and to which the PPS resin [1] is applied as the matrix resin to the fiber-reinforced composite material obtained in the step 1 to obtain a molded article.

20. The method according to claim 19, wherein the step 1 comprises steps 1-A and 1-B:
Step 1-A: a step of laminating the fiber-reinforced base material [A] and the fiber-reinforced base material [B], heating a laminate to 200 to 280° C., and bonding the laminate to form an intermediate molded article; and
Step 1-B: a step of heating the intermediate molded article to 280 to 450° C. to mold the intermediate molded article into a specific shape.
